(19) United States
(12) Patent Application Publication
(10) Pub. No.: US 2025/0290532 A1
(43) Pub. Date: Sep. 18, 2025

(54) HOLLOW STRUCTURE ANCHOR

(71) Applicant: Siemens Aktiengesellschaft, Munchen (DE)

(72) Inventor: James Donovan RULE, Hertfordshire (GB)

(21) Appl. No.: 18/860,306

(22) PCT Filed: Apr. 26, 2023
(86) PCT No.: PCT/GB2023/051113

§ 371 Date: Oct. 25, 2024

(30) Foreign Application Priority Data
Apr. 27, 2022 (GB) 2206152.7

(51) Int. Cl. F16B 13/04

(52) U.S. Cl. CPC F16B 13/04

(57) ABSTRACT

A hollow structure anchor to receive a screw and in combination with this, secure an object to the face of the hollow structure board or board covering. The anchor comprises a main part, cylindrically shaped with an aperture. This aperture receives a screw to secure an object against the face of a board structure. The anchor main body adjoins a part approximately perpendicular to this aperture and screw. This part is inserted through a pre made hole in a board, and then the anchor rotated approximately 90 degrees as it passes through. The screw is then inserted through the object and anchor aperture. This creates resistant force on the anchor perpendicular part against the rear of the board. Two said anchors can be pivotally connected to be used in conjunction with one another.

### TECHNICAL FIELD OF THE INVENTION

An anchor for receiving a screw in a hollow type structure board, such as plasterboard, to provide a means of secure fixing of an object.

### BACKGROUND OF THE INVENTION

The present invention relates to an anchor for receiving a screw in a hollow wall, or ceiling, which is most commonly made including plasterboard.

To fix an object to plasterboard, or similar lightweight board, it is necessary to use an anchor which can then in turn receive a screw for achieving a secure fixing. The board itself is not capable of receiving a common screw directly without an anchor, as this does not create a strong fixing and the screw will often become loose.

Common existing anchors used generally need a hole to be made in the board to receive them. These holes can vary in size and shape. Some anchors also require additional procedures to be undertaken by the installer to achieve the intended result.

Existing anchors pose different difficulties and problems.

Some current anchors which are the ‘cylindrical wall plug’ type, work on resistance being formed when the screw is inserted into the anchor due to the screw causing the anchor to change form at the rear of the plasterboard. Unfortunately, this often results in the anchor turning, rather than changing form, making the resistance created for the fixing screw to be very weak or non-existent. Even when these are installed correctly, they only provide limited amount of resistance for securing items due to their design.

Other existing style anchors, such as the ‘screw in’ type anchors, can often lose their pull force strength at both stages of inserting the anchor itself, or the inserting of the screw. This is due to the plasterboard having limited strength and resistance against this type of design. The plasterboard structure often becomes weakened at the area around the anchor due to its brittle property and other boards such as ply wood are too strong for this type of anchor to be used.

Although some existing anchors currently on the market such as the ‘Gripfit’ anchor can be effective in providing a strong anchor or fixing with plasterboard, these are quite skilled and time consuming to install correctly, especially when a structure has been double boarded (2 layers of board overlapped on the structure). These are also costly in comparison to more simplistic designed anchors, due to the design complexity increasing manufacturing costs. For professionals using anchors regularly, speed, ease of installation and cost of the anchors are important factors.

The most effective existing anchors also require large holes or take up large surface area once installed which is often not desirable for a lot of applications where the anchor is then visible after the works have been completed. Some even require the bore hole to be formed in a separate area to where the fixing screw is required. For example, when a small bracket, such as a shelf bracket is being installed, it often does not cover the entire face side of the anchor after installation and therefore the anchor is still visible after the bracket has been installed.

Some anchors also leave parts extending beyond the face of the board structure after installation which obstructs the object being installed from being installed tightly against the face of the board, which is often undesirable.

### SUMMARY OF THE INVENTION

The present invention overcomes the above problems and provides a strong anchor fixing point in plasterboard and other type hollow board structures. It is an anchor using a simple component design to keep the cost of production low. It is also simple and fast to install ready to receive a screw fixing by the installer. It is a component design based on an ‘L’ shape, comprising of the main body and a perpendicular leg to form this said ‘L’ shape.

A bore hole must be formed in the plasterboard to receive the anchor. The anchor is then installed into the hole. After the anchor is installed within this hole, a screw is then inserted into the anchor through an object being installed. When this object comes into contact with the face of the board, or board covering such as plaster or tiles, a canter lever force is created resisting the anchor from returning back through the pre made bore hole in a reverse action to which it was installed.

Once a screw is inserted, it provides a strong and sturdy anchor, with good pull force resistance to the hollow structure boarding.

The present invention resists the anchor from unwanted rotation when the screw is being inserted.

The present invention also provides resistance from the anchor being pushed entirely out through the back of the plasterboard when the screw is being installed by a user.

This is achieved by the main cylindrical shaped part of the body, mostly being of a size consistent with that of the bore hole made, apart from some elements protruding beyond this size to create friction and resistance on the wall of the bore hole. The resistant is enough to maintain the anchor position when the user is installing the screw, however is not resistant enough to cause structural damage to the board area in the proximity of the anchor to ensure the anchor remains effective after installation within the said bore hole. The design is such that the anchor is rotated into position with the ‘leg’ of the anchor against the rear or the board. During this procedure of rotation, the entire anchor has passed the front face of the board to eliminate any obstruction to an object being attached to the face of the board structure. This means the anchor is not limited by additional thicknesses of board structures such as plaster top coat, or double layered boarding, as the anchor can pass beyond additional thickness coverings due to its design. Although it can pass beyond the face of the board structure, it has a means to give some resistance to this motion along with a means to resist rotational force around the axis of the aperture for receiving the fixing screw.

It is designed with little to no moving parts making it durable and cheap to manufacture.

It is easy and fast to install, requiring only a hole to be made in the board. The anchor is then inserted into the hole, with this being the only step procedures required to prepare the anchor ready for an object to be installed against the surface.

Preferably the anchor will have a pre made hole or aperture, threaded or unthreaded, to accept a wood thread type screw or a metal thread type screw.

Preferably the anchor will have a reduce width of leg, at least in part, to that of the main cylindrical body to assist easy installation with a shallow void necessary behind the board.

The aperture for receiving the fixing screw may also include a chamfered initial part to help receive the tip of the screw and help alignment into the aperture

The anchor may also be designed using two of the said ‘L’ shaped anchors, pivotally connected, to create two ‘back-to-back’ type anchor's which are inserted into the same bore hole in the plasterboard. This can create an even stronger pull and rotational resistance for a screw fixing. Preferably this design will also use an interlocking feature when the screw is inserted through both 2 anchors.

Preferably the design will include features to make accurate installation easy such as a feature to indicate the direction of the leg when installed. This would be helpful when installing two anchors in close proximity to avoid obstruction of the legs behind the board.

Attempts have been made to create similar designs, however, they have all relied on the front face of the board structure to align the anchors upon installation. Boards can vary in thickness, as can the board covering such as the plaster or tiles overlaid. Boards themselves can also at times be double layered. This use of the front face and rear face of a board structure for an anchor design makes them limited, or complex in design, for achieving practical application due to boards and board coverings varying in overall thickness between the front face and rear face.

Patent EP3382214A1 uses a similar design but, unlike mine, intends for the fixing screw to be located in an alternate position to that of the cylindrical part of the body, in the leg of the anchor. This means no anti rotational part is required.

Patent CA2643664A1 and patent WO2020070478A1 have also been noted to use a similar design, however again both are limited by the front face of the board, or board covering, making these designs very limited in their effectiveness in reality.

Patent application PCT/GB2020/052771 is again another similar design currently on the market but relies on an additional component first installed within the bore hole created in the board. This additional component again sits forward of the face of the board creating an obstruction between the object being attached and the face of the board or board covering. This design is also limited to work only within limited total board thicknesses because of this.

### BRIEF DESCRIPTION OF THE DRAWINGS

An example of the invention will now be described by referring to the accompanying drawings:

FIG. 1. Shows a perspective of an anchor with a bore hole ready to receive a fixing screw through the main body of the anchor at approximately 90 degrees to the leg of the anchor, according to the invention;

FIG. 2. Shows a perspective of an exemplary design of an anchor with a reduced section in the lower main body area, according to the invention;

FIG. 3. Shows a perspective of an exemplary design of an anchor with a protruding design feature on the upper side of the leg, according to the invention;

FIG. 4. Shows a perspective of an exemplary design of an anchor with an angular part between the main body and leg of the anchor, according to the invention;

FIG. 5. Shows a perspective of an exemplary design of an anchor with a protruding part at the top of the main body, according to the invention;

FIG. 6. Shows a perspective of an exemplary design of an anchor with an alternative shape leg, according to the invention;

FIG. 7. Shows a perspective of a section through plasterboard including a hole ready to receive an anchor;

FIG. 8. Shows a perspective of an anchor part way through rotation when being installed through a hole in plasterboard, according to the present invention;

FIG. 9. Shows a perspective of an anchor in position within the plasterboard hole ready to receive the fixing screw, according to the present invention;

FIG. 10. Shows a perspective of an anchor within the plasterboard and with a screw inserted in the anchor, according to the invention;

FIG. 11. Shows a perspective of the face side of the plasterboard with an anchor installed below the face surface of the plaster or plaster board, according to the invention;

FIG. 12. Shows a perspective of an exemplary design of anchor with a secondary protruding element to resist movement from the cylindrical body positioned opposite the first;

FIG. 13. Shows a perspective of an exemplary design of anchor, with a multiple of elements protruding from the main cylindrical shaped body and a leg with reduced angular planes, according to the present invention;

FIG. 14. Shows a perspective of an exemplary design of an anchor with the main body in an alternative shape to assist with installation, according to the present invention;

FIG. 15. Shows a perspective of an exemplary design of an anchor with a threaded bore hole, according to the present invention;

FIG. 16. Shows a perspective of an exemplary design of an anchor with an alternative shape aperture, according to the present invention;

FIG. 17. Shows a perspective of an exemplary design of an anchor with a countersunk top, according to the present invention;

FIG. 18. Shows a perspective of an exemplary design of an anchor with a design feature to allow the shape of the anchor to alter when the screw is inserted, according to the present invention;

FIG. 19. Shows an exemplary design of an anchor with two pivotally connected anchors illustrated at different stages of position when being installed, according to the present invention;

FIG. 20. Shows a perspective of an anchor with a leg less than that of ninety degrees relative to the aperture for receiving the screw fixing, according to the present invention;

FIG. 21. Shows a perspective of an anchor with a leg more than that of ninety degrees relative to the aperture for receiving the screw fixing, according to the present invention;

FIG. 22. Shows a perspective of an exemplary design of an anchor with an extended leg, according to the invention.

FIG. 23. Shows a perspective of an anchor, positioned within a board, including the screw and object being mounted, to illustrate how the anchor works with installing objects to boards with a screw, according to the present invention.

FIG. 24. Shows a perspective of an exemplary design of an anchor, with an enlarged circular angled plane at the upper part of the cylindrical body and a curved anti rotational and leg support, according to the present invention.

FIG. 25. Shows a perspective of an exemplary design of an anchor, with an enlarged stepped section at the upper part of the cylindrical body and a straight anti rotation and leg support, according to the present invention.

FIG. 26. Shows a perspective of an exemplary design of an anchor, including a curved section to the end part of the leg, according to the present invention.

FIG. 27. Shows a perspective of an exemplary design of an anchor, showing a leg shaped to form a stepped part, according to the present invention.

FIG. 28. Shows a perspective of an exemplary design of an anchor, with an aperture design combining a cross and a cylindrical shape, according to the present invention.

FIG. 29. Shows a perspective of an exemplary design of an anchor with the anchor being of larger dimensions, including that of the cylindrical part of the body, according to the present invention.

FIG. 30. Shows a perspective of an exemplary design of an anchor, whereby the leg is less in width to that of the circumference of the main cylindrical body, according to the present invention.

### DETAILED DESCRIPTION OF THE INVENTION

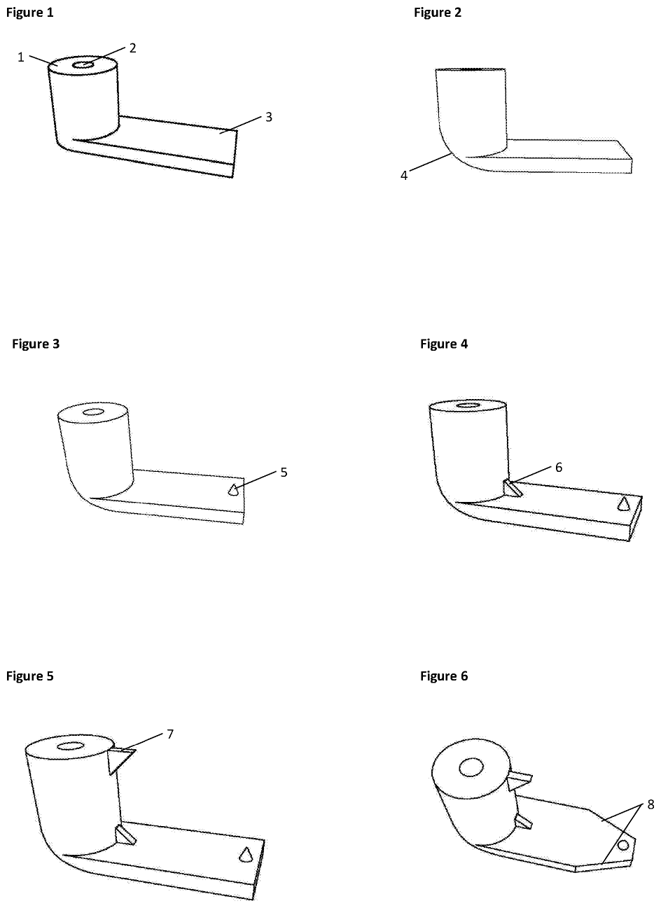

FIG. 1 shows a perspective of an anchor. It has a main body (1) with a bore hole (2), and a leg (3). The bore hole (2) is an aperture designed to accept a screw fixing (12) to be installed. The anchor is designed to be installed within a bore hole (11) through a hollow structure board (9) such as plasterboard. Once installed, the anchor is designed to sit either flush, or below the face of the board or board covering. When an object (23) is to be attached to a wall or ceiling made from a hollow structure board such as plasterboard, a screw (12) is installed through the said object and into the anchor installed within the plasterboard. When an object being attached comes into contact with the surface of the plasterboard (9), and the screw (12) tightened though the object and into the anchor, a counter force resistance is created between the screw, object, board and anchor. This provides a secure fixing of an object to the face of the board structure.

The outer body shape of the anchor may be altered for a number of potential benefits in design.

To install the anchor, the leg (3) is first installed through the pre made hole in a board. As the leg passes through the pre made hole, the anchor is then rotated around approximately 90 degrees to align the upper face of the leg with the rear of the board. Sometimes structures have two overlapping layers of board and this would be the same procedure through a bore hole through the two boards in these scenarios.

In reference to FIG. 2, this shows the lower section (4) of the main body being curved in design to assist the ease of rotation when the anchor is being installed through the pre made bore hole in the board. This feature could alternatively be angular instead of curved to achieve a similar benefit.

In reference to FIG. 14, this shows an anchor body with an outer diameter (14) which reduces in size over the length of the main body, as an alternative design feature, to help with this necessary rotation when installing the anchor through the board bore hole. This reduction by way of angling the main cylindrical body could be around the entire circumference surface of the main body, or limited only to the side of surface furthest from the leg of the anchor, whilst keeping the surface closest to the leg parallel with the screw aperture.

Once the anchor is installed within a board, a fixing screw for attaching an object can then be inserted into the aperture within the anchor main cylindrical body. Due to the friction between the screw and anchor, the anchor may rotate in the same direction as the screw during this process which is undesirable, and renders the anchor in-effective. There are a number of design features that would help resist this unwanted rotation.

In reference to FIG. 3, it shows an additional feature (5) which causes additional friction between the anchor leg and rear of the board when installed to resist this unwanted rotation.

In reference to FIG. 4, this shows an additional feature (6) which also helps create resistance between the anchor and board to limit unwanted rotation when installing the fixing screw. This feature also creates an additional strength between the main body and leg of the anchor.

In reference to FIG. 5, this shows a feature (7) which helps resist unwanted rotation of the anchor, and to give a small resistance when pushing the anchor through the bore hole. These help when installing a fixing screw into the anchor to stop continued unwanted movement of the anchor. This feature also creates resistance against the face of the board during the installation of the anchor within the bore hole, to assist with the necessary rotation of the anchor for alignment within the bore hole. This feature could also be positioned lower down the cylindrical main body.

In reference to FIG. 6, this shows a leg with reduced sections (8) to help with the installation of the anchor through the pre made bore hole in the board.

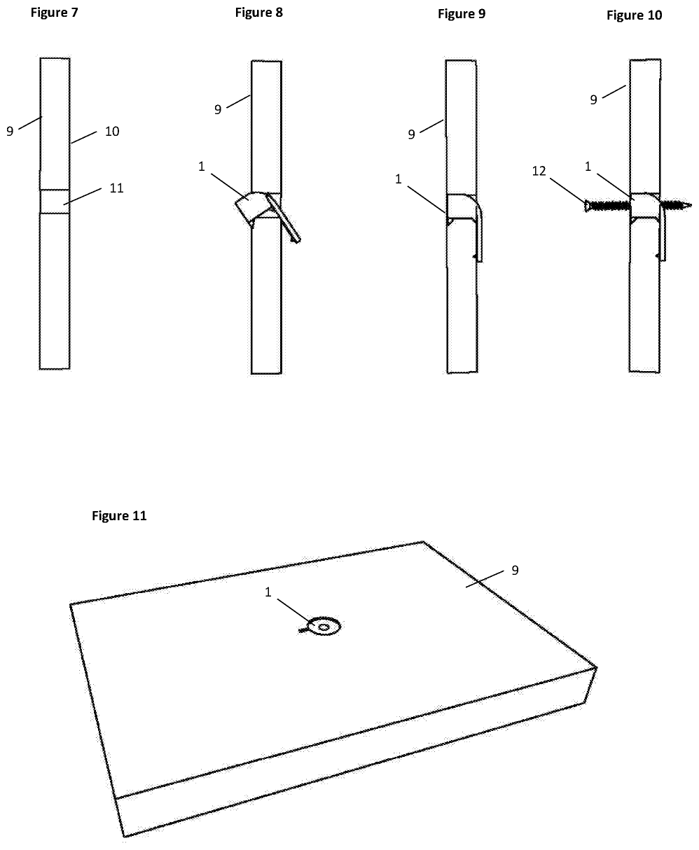

In reference to FIGS. 7, 8, 9 and 11, these show how the anchor is installed through a pre made bore hole (11) in a board ready to accept a screw fixing.

FIGS. 9 and 11 show two perspectives of the anchor in its fitted position within the hole (11) relative to the face (9) and rear (10) of the board.

FIG. 10 shows a screw (12) and its relative direction within the anchor when inserted.

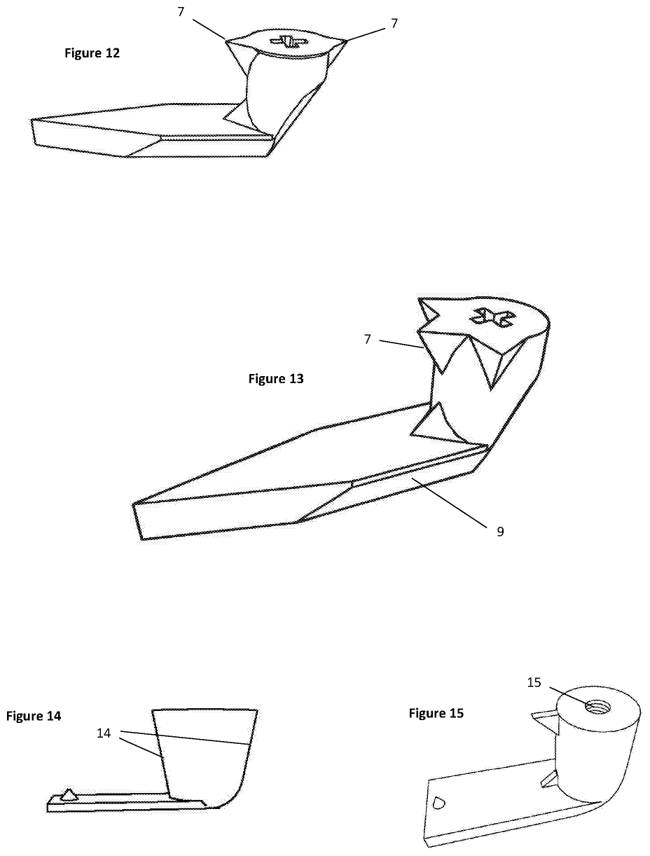

FIG. 12 shows a feature (7) that creates resistance within the plasterboard bore hole to help limit the anchor from being installed unwantedly too far beyond the front face of the board. When inserting the anchor within the pre made hole in the board, it is necessary for the anchor to rotate approximately 90 degrees, in preparation for receiving the fixing screw. It is important during completing this procedure for the anchor to only pass the front face of the board, and not to be pushed beyond the front and rear face of the board (9). FIG. 12 shows two of these features (7) positioned opposite one another to create more balanced forces to help align the anchor centrally within the bore hole.

These features (7) also resist the anchor from unwanted rotation in a similar rotational direction to that of the screw when the screw is being inserted into the anchor. The feature (7) shown in FIG. 12, is also shaped to help insertion of the anchor beyond the face of the board within a bore hole, and reduce the impact of these features on the structural integrity of the board in the proximity of the anchor to enable the anchor to remain effective after installation.

FIG. 13 shows a multiple of these movement resistant features (7) positioned towards the leg side of the cylindrical body, to assist with increased rotational forces when rotating and aligning the anchor within a bore hole in the plasterboard. FIG. 13 also shows reduced sections to create angular parts (9) to the sides of the leg (3) to assist with the anchor passing through the pre made bore hole in the plasterboard. This angular reduction could also be designed towards the upper section of the leg to achieve similar benefits.

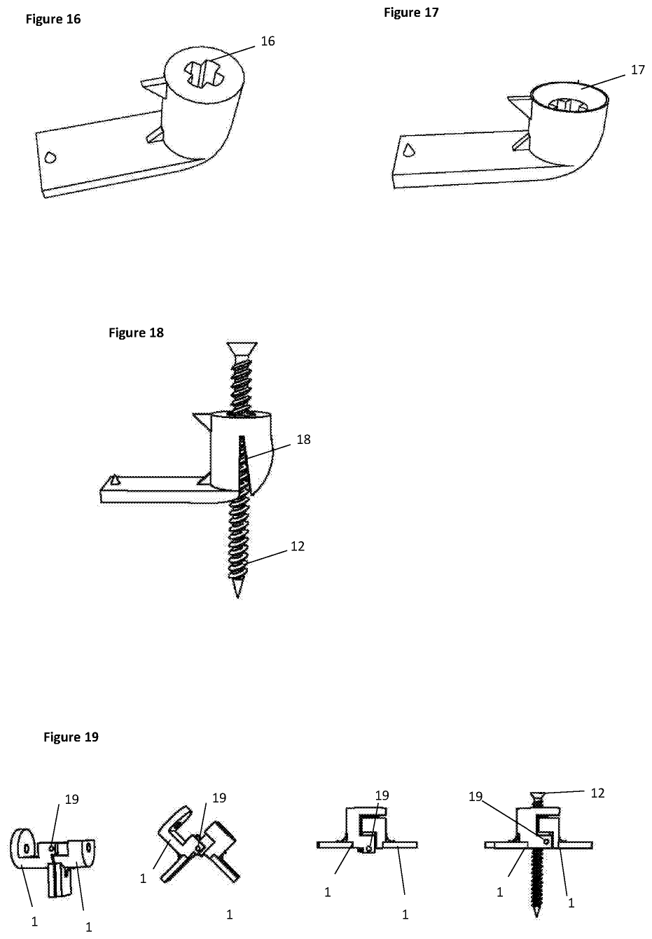

In reference to FIGS. 16 and 28, the aperture, or bore, for receiving the screw fixing can be a simple cylindrical shape (2) to receive a wood thread type screw, or pre threaded (15) to receive a metal thread type screw. The aperture may also be altered partly or entirely to that of what is other than cylindrical (16) to help assist with the installation of a screw and reduce unwanted friction between the screw and anchor. The aperture can also be made from a shape combining both a cylindrical shape, and cross type shape (30), to enable a multiple choice of fixing screws to be used with the anchor.

In reference to FIG. 17, this shows an aperture for receiving a screw with a counter sunk top (17) to help receive a screw.

In reference to FIG. 18, this shows an anchor which incorporates a feature (18) to help alter the anchors shape when the screw is inserted to create additional pressures and friction between the anchor and the plasterboard. This helps resist unwanted rotation of the anchor when installing the screw, and helps increase pull force resistance to achieve secure mounting of an object to a board.

In reference to FIG. 19, similar anchoring can be achieved using 2 anchors pivotally connected (19). Each anchor has its own separate bore or aperture for receiving the screw fixing which are aligned when the anchors are inserted through a hole in a board and each rotated approximately 90 degrees. This alignment of the said apertures creates an interlocking positioning between the two pivotally connected anchors when a screw is inserted to resist a reversed rotation of the said anchors.

A cone like design of the main cylindrical bodies similar to that referenced in FIG. 14, would be helpful when the anchors are pivotally connected to assist in the rotation of the anchors within an aperture of a board also.

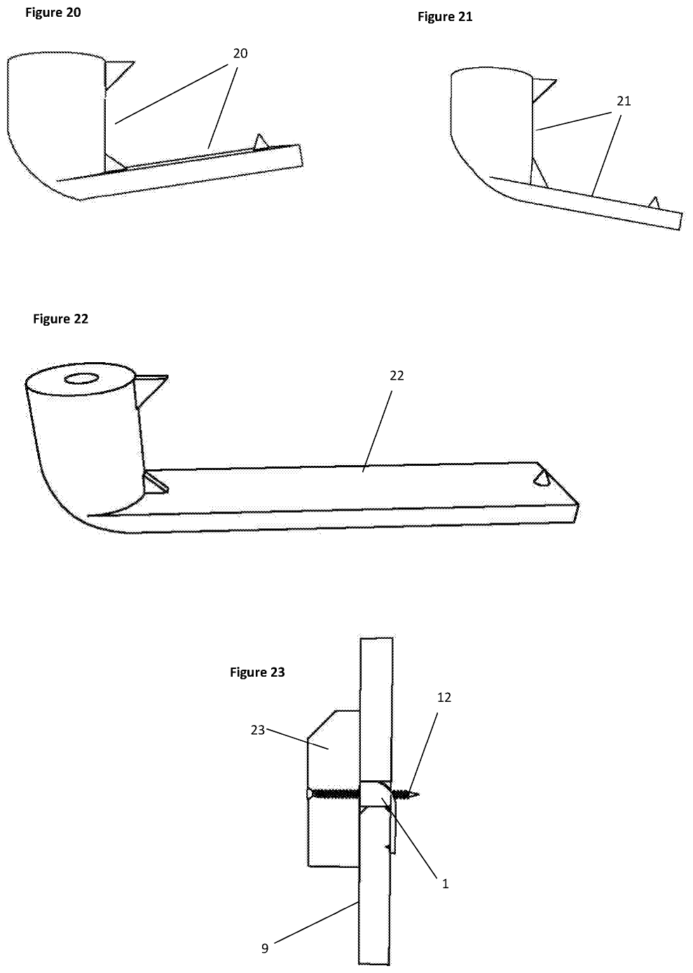

In reference to FIG. 20, to help obtain correct alignment and installation of the anchor, the leg may be slightly less than that of 90 degrees (20) to that of the aperture for receiving the screw fixing.

In reference to FIG. 21, to help obtain correct alignment and installation of the anchor, the leg may be slightly more than that of 90 degrees (21) to that of the aperture for receiving the screw fixing.

In reference to FIG. 22, the leg may be extended (22) to increase resistance when installed and assist installation through thicker board structures.

In reference to FIG. 23, this shows how the screw (12), anchor (1), board (9) and object being attached (23) interact with each other on completion of installation.

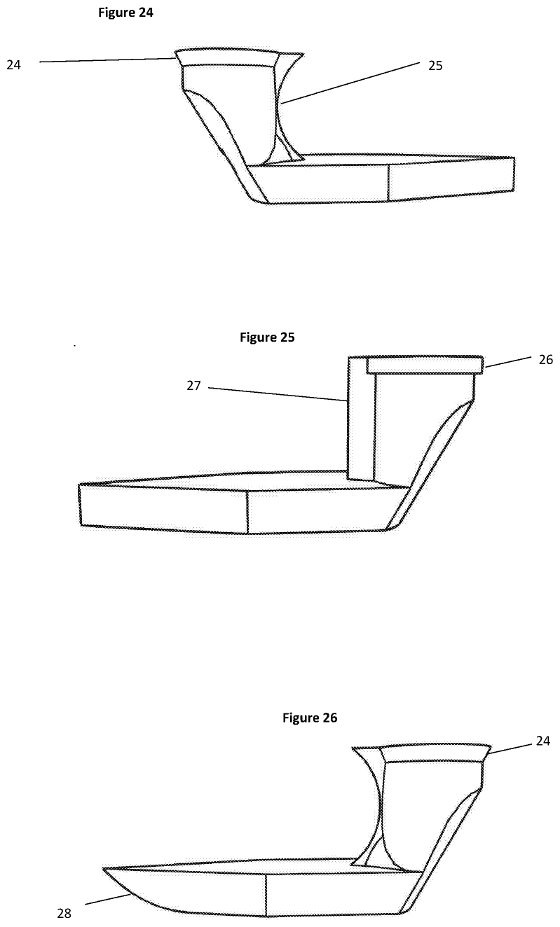

FIG. 24 shows an angular protruding element (24) around the upper cylindrical part of the main body to help with rotation of the anchor upon installation within the bore hole. This element (24) also resists the anchor from being forced too far through the bore hole and beyond the rear face of the board upon installation of the anchor and fixing screw. FIG. 24 also shows an anti-rotational part (7) and leg support (6) connected as a continuous curved protruding element (25) from the main cylindrical body. This element (25) is curved between the upper and lower sections to assist with the installation of the anchor within the plasterboard bore hole.

In reference to FIG. 25, this shows an anti rotational element (7) and leg support (6) as a continuous straight protruding feature (27) the entire length of the cylindrical main body to the upper surface of the leg. FIG. 25 also shows an alternative method to create depth resistance when installing this type of anchor within a plasterboard bore hole. The upper section of the cylindrical main body has an enlarged stepped feature (26) which is slightly larger than the cylindrical shaped body to achieve a similar effect to that of feature 24. This stepped feature (26) is large enough to create friction within the plasterboard bore hole but not large enough to stop the anchor from being able to pass the front face of the board without causing structural damage rendering the anchor ineffective. The most common thickness plasterboard is 12.5 mm and so preferably this design would have a cylindrical body which is no more than 12.5 mm in height from the upper surface of the leg, to the upper surface of the cylindrical body, when measured parallel to the aperture for receiving the screw. This ensures the anchor does not protrude beyond the front face of board when installed.

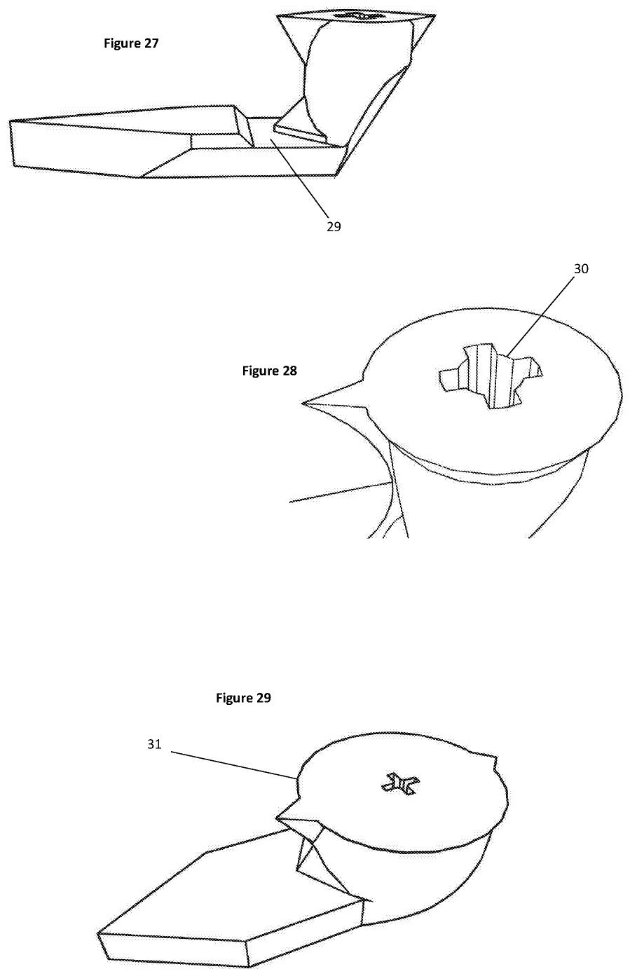

In reference to FIG. 26, this shows an additional feature (28) of an alternative shape leg to assist with the installation of the anchor. This helps with both going through a board, and the rotation of the anchor when being installed through a board.

In reference to FIG. 27, often when creating bore holes in plasterboard, unwanted debris can be created around the rear of the bore hole. A stepped feature (29), or similar, at the end of the leg nearest the main cylindrical body would help clear obstructions like this. This feature (29) would also assist with the installation of the anchor through a bore hole in the plasterboard and help reduce any unwanted obstruction between the leg support (6) and plasterboard bore hole.

In reference to FIG. 29, this shows an anchor with a larger diameter main cylindrical body (31) which also has a larger leg and larger aperture for receiving larger screws or bolts.

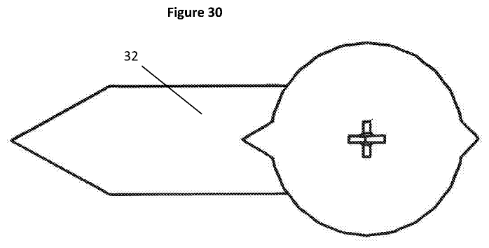

In reference to FIG. 30, it shows a leg (32) with a width less than that of the diameter of the main cylindrical body to help with installation.

The anchors have been designed such that the distance from the top surface of the leg which comes into contact with the rear face of the plasterboard, and the top surface of the main cylindrical body, is equal or less to that of the board, or board and board covering, to ensure the anchor does not protrude beyond the front face of the board, or board covering, after installation. This allows the anchor to be used in double layered boards, or various board and board covering thicknesses, due to not being restricted by the limitation of the front face of the board or board covering.

The anchor main body may be designed in various diameters to allow various size screw apertures and legs for various applications, and to increase resistant forces.

The material of the anchor may be various materials such as a metal or plastic, or combination of materials.

Plasterboard and cement board are the most commonly used board as hollow structure boarding and are commonly 12.5 mm in thickness. Therefore, the main body of the anchor when measured parallel to the aperture for receiving the fixing screw, from the upper surface of the leg to the upper surface of the cylindrical main body, is no greater than the thickness of the board to ensure the upper part of the cylindrical body does not extend beyond the face of the board when the leg abuts the rear of the board. Alternatives can be designed to work with other thickness boarding's such as ply wood which is commonly made at 6 mm, 12 mm 18 mm and 25 mm in thickness, or other plasterboard such as 9.5 mm thick board. The anchor may also be designed to be more specifically suitable for a variety of board thicknesses and surface coverings such as double layered boarding or boarding with additional coverings such as tiles or plaster.

1. A single component hollow structure anchor comprising:
a cylindrical shaped main body;
an aperture (2) for receiving a screw within the cylindrical main body;
a part (3) perpendicular to the aperture at one end of the cylindrical shaped main body;
at least one protruding element (7/14/24/26) to resist movement in both lateral and rotational direction when inserted within a bore hole of similar diameter to that of the main cylindrical body; and
the cylindrical shaped main body designed to not protrude beyond the front face of a board structure when installed.

2. An anchor according to claim 1 defining a feature (6) to increase strength between the cylindrical shaped main body and the perpendicular part.

3. An anchor according to claim 1 defining a protruding feature (5) on the upper surface of the part perpendicular to the aperture.

4. An anchor according to claim 1 defining a protruding element (7) on a cylindrical surface of the main body.

5. An anchor according to claim 1 wherein;
the cylindrically shaped main body is cylindrically shaped only in an upper section thereof due to part of the cylindrical shape being removed in lower section thereof (4,14).

6. An anchor according to claim 1 wherein:
the part perpendicular to the aperture is reduced in size at the end (8) furthest from the main body.

7. An anchor according to claim 1 wherein:
the part perpendicular to the aperture is less in width (32) to that of a diameter of the main body.

8. An anchor according to claim 1 wherein:
the main body defining an extended feature (24/26) around the cylindrical shaped part of the main body.

9. An anchor according to claim 1 wherein:
the aperture defines threading (15).

10. An anchor according to claim 1 wherein:
the aperture defines a bore shape (16/30) other than that of a cylindrical bore shape.

11. An anchor according to claim 1 wherein:
an upper part (17) of the aperture defines an annual chamfer.

12. An anchor according to claim 1 wherein
the cylindrical shaped main body defines a means (18) to alter its external shape when a screw is inserted within the aperture.

13. An anchor according to claim 1 wherein:
a first single component anchor (19) is pivotally connected to a second single component anchor;
the first and second component anchors defining interconnecting shapes to enable the apertures of each component anchor to align when rotated;
the first and second component anchors defining shapes to allow the first component anchor to rotate a minimum of 90 degrees relative to the second component anchor.

14. An anchor according to claim 1 wherein:
the part perpendicular to the aperture (20) is between that of 90 and 1 degrees relative to the aperture.

15. An anchor according to claim 1 wherein:
the part perpendicular to the aperture (21) is between that of 90 and 179 degrees in relation to the aperture.

16. An anchor according to claim 1 wherein:
the part perpendicular to the aperture (22) has a longer dimension to that of the length of the cylindrical shaped main body.

17. An anchor according to claim 1 wherein:
the cylindrical shaped main body has an external measurement of anywhere between 0-1000 mm.

18. (canceled)
